(19) United States
(12) Patent Application Publication
(10) Pub. No.: US 2007/0248781 A1
(43) Pub. Date: Oct. 25, 2007

(54) Photochemical and photothermal rearrangements for optical data and image recording

(76) Inventor: Makarand P. Gore, Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/410,728

(22) Filed: Apr. 25, 2006

(51) Int. Cl. B32B 3/02

(52) U.S. Cl. 428/64.4

(57) ABSTRACT

Systems and method for optically recording data. One optical recording medium comprises a substrate and a markable coating on said substrate, the markable coating comprising a matrix containing a color-forming agent comprising a leuco dye and developer precursor, wherein said developer precursor comprises a compound that undergoes photochemical or thermal rearrangement in response to a stimulus so as to become a developer for the leuco dye.

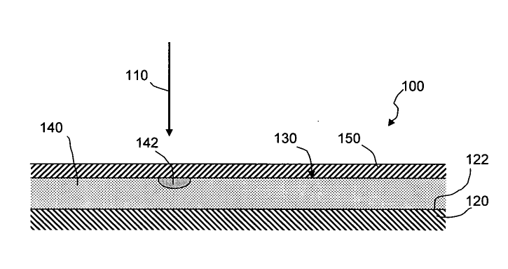

### BACKGROUND

Materials that produce color change upon stimulation with radiation are used in optical recording and imaging media and devices. Further, widespread adoption of and rapid advances in technologies relating to optical recording and imaging media have created a desire for greatly increased data storage capacity in such media. Thus, optical storage technology has evolved from the compact disc (CD) and laser disc (LD) to far denser data types such as digital versatile disc (DVD) and blue laser formats such as BLU-RAY and high-density DVD (HD-DVD). “BLU-RAY” and the BLU-RAY Disc logo mark are trademarks of the BLU-RAY Disc Founders, which consists of 13 companies in Japan, Korea, Europe, and the U.S.

In each case, the optical recording medium comprises a substrate, typically a disc, on which is deposited a layer on which a mark can be created. In some media the mark is a “pit,” or indentation in the surface of the layer, and the spaces between pits are called “lands.” A marked disc can be read by directing a laser beam at the marked surface and recording changes in the reflected beam. An imaging medium consists of any surface coated with material activated by light.

It remains desirable to improve the markability and manufacturability of optical recording media while reducing cost and complexity.

### BRIEF DESCRIPTION OF THE DRAWING

For a detailed description of exemplary embodiments of the invention, reference will now be made to the accompanying drawing, which shows an imaging medium according to an embodiment of the present invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “comprising, but not limited to . . . .”

Reference is made herein to BLU-RAY technologies. DVD specifications for BLU-RAY discs currently include the following: wavelength=405 nm; numerical aperture (NA)=0.85; disc diameter=12 cm; disc thickness=1.2 mm; and data capacity≧23.3/25/27 GB. BLU-RAY discs can currently be used to store 2 hours high resolution video images or 13 hours conventional video images. A blue-violet laser having a wavelength between 380 nm and 420 nm, and particularly 405 nm is used as the light source for BLU-RAY discs. Another technology using blue light (380˜420 nm radiation) is HD-DVD.

As used herein, the term “leuco dye” refers to a color-forming substance that is colorless or one color in a non-activated state and that produces or changes color in an activated state. As used herein, the terms “developer” and “activator” describe a substance that reacts with the dye and causes the dye to alter its chemical structure and change or acquire color.

The term “light” as used herein includes electromagnetic radiation of any wavelength or band and from any source.

### DETAILED DESCRIPTION

Referring briefly to the drawing, there is shown an imaging medium 100 and energy beam 110. Imaging medium 100 comprises a substrate 120 and an marking layer 130 on a surface 122 of substrate 120. In the embodiment shown, imaging medium 100 further comprises a protective layer 150, such as is generally known. As described in detail below, marking layer 130 preferably comprises a color-forming agent suspended or dissolved or finely dispersed in a matrix or binder 140. Marking layer 130 may comprise a polymeric matrix and may include an optional fixing agent (not shown).

Substrate 120 may be any substrate upon which it is desirable to make a mark, such as, by way of example only, the polymeric substrate of a CD-R/RW/ROM, DVD±R/RW/ROM, HD-DVD or BLU-RAY disc. Substrate 120 may be paper (e.g., labels, tickets, receipts, or stationery), overhead transparency, or other surface upon which it is desirable to provide marks. Marking layer 130 may be applied to substrate 120 via any acceptable method, such as, by way of example only, rolling, spin-coating, spraying, lithography, or screen printing.

In many embodiments, it will be desirable to provide a marking layer 130 that is less than one micron (μm) thick. In order to achieve this, spin coating is a suitable application technique. In addition, it is desirable to provide a marking composition that is capable of forming a layer having the predetermined thickness. In such cases, the marking layer should be, inter alia, free from particles that would prevent such a layer, i.e., free from particles having a dimension greater than 1 μm. The marking composition is more preferably, but not necessarily, entirely free of particles.

When it is desired to make a mark, marking energy 110 is directed in a desired manner at imaging medium 100. The form of the energy may vary depending upon the equipment available, ambient conditions, and desired result. Examples of energy that may be used include, but are not limited to, infra-red (IR) radiation, ultra-violet (UV) radiation, x-rays, or visible light. In these embodiments, imaging medium 130 is illuminated with light having the desired predetermined wavelength at the location where it is desired to form a mark. The marking layer absorbs the energy, causing a photochemical change in marking layer 130, resulting in an optically detectable mark 142.

The color-forming agent may be any substance that undergoes a detectable optical change in response to a threshold stimulus, which may be applied in the form of light. In some embodiments, the color-forming agent comprises a leuco dye and a developer, as described in detail below. The developer and the leuco dye produce a detectable optical change when chemically mixed.

In preferred embodiments, both the developer and the leuco dye are soluble in the matrix. In other embodiments, one of the components may be suspended in the matrix as distributed particles, but homogenous coatings are preferred. The concentration and distribution of the color-forming agent in marking layer 130 are preferably sufficient to produce a detectable mark when activated.

In embodiments where the color-forming agent comprises two components, such as a leuco dye and a developer, one of the components of the color-forming agent can be provided in marking layer 130 as a precursor of the desired component. In these embodiments, the incident light triggers a chemical change in the precursor, causing it to become the desired component. Once the desired component is formed, both components of the color-forming agent will be present locally and the color-forming reaction occurs. Thus, if energy is applied to the desired region of marking layer 130, an optically detectable mark 142 can be produced.

The resulting mark 142 can be detected by an optical sensor, thereby producing an optically readable device. Depending on the color-forming agent selected, the marking composition may become relatively more or relatively less absorbing at a desired wavelength upon activation. Because many commercial and consumer products use a single wavelength for both read and write operations, and because a color-forming agent that produces a mark that is relatively absorbing (relative to the unmarked regions) at the read wavelength is particularly advantageous, it is desirable to provide a color-forming agent that produces a mark that is relatively absorbing at the read/write wavelength.

Thus, by way of example only, if blue-violet light (radiation) is to be used as the read radiation, the marks formed in the marking layer are preferably contrasting color, namely yellow to orange, indicating absorption of blue radiation. In certain embodiments, therefore, the marking composition contains a leuco dye that, when activated, changes from being relatively non-absorbing at blue-violet wavelengths to being relatively absorbing at the those (i.e., yellow/orange) wavelengths.

Nonetheless, embodiments of the present invention are not limited to such dyes. Specific examples of leuco dyes suitable for use in embodiments of the present invention include fluorans and phthalides, which include but are not limited to the following and which can be used alone or in combination: 1,2-benzo-6-(N-ethyl-N-toluidino)fluoran, 1,2-benzo-6-(N-methyl-N-cyclohexylamino)fluoran, 1,2-benzo-6-dibutylaminofluoran, 1,2-benzo-6-diethylaminofluran, 2-(.alpha.-phenylethylamino)-6-(N-ethyl-p-toluidino)fluoran, 2-(2,3-dichloroanilino)-3-chloro-6-diethylaminofluran, 2-(2,4-dimethylanilino)-3-methyl-6-diethylaminofluoran, 2-(di-p-methylbenzilamino)-6-(N-ethyl-p-toluidino)fluoran, 2-(m-trichloromethylanilino)-3-methyl-6-(N-cyclohexyl-N-methylamino)fluoran, 2-(m-trichloromethylanilino)-3-methyl-6-diethylanimofluoran, 2-(m-trifluoromethylaniline)-6-diethylaminofluoran, 2-(m-trifluoromethylanilino)-3-chloro-6-diethylaminofluran, 2-(m-trifluoromethylanilino)-3-methyl-6-diethylanimofluoran, 2-(N-ethyl-p-toluidino)-3-methyl-6-(N-ethylanilino)fluoran, 2-(N-ethyl-p-toluidino)-3-methyl-6-(N-propyl-p-toluidino)fluoran, 2-(o-chloroanilino)-3-chloro-6-diethlaminofluoran, 2-(o-chloroanilino)-6-dibutylaminofluoran, 2-(o-chloroanilino)-6-diethylaminofluoran, 2-(p-acetylanilino)-6-(N-n-amyl-N-n-butylamino)fluoran, 2,3-dimethyl-6-dimethylaminofluoran, 2-amino-6-(N-ethyl-2,4-dimethylanilino)fluoran, 2-amino-6-(N-ethylanilino)fluoran, 2-amino-6-(N-ethyl-p-chloroanilino)fluoran, 2-amino-6-(N-ethyl-p-ethylanilino)fluoran, 2-amino-6-(N-ethyl-p-toluidino)fluoran, 2-amino-6-(N-methyl-2,4-dimethylanilino)fluoran, 2-amino-6-(N-methylanilino)fluoran, 2-amino-6-(N-methyl-p-chloroanilino)fluoran, 2-amino-6-(N-methyl-p-ethylanilino)fluoran, 2-amino-6-(N-methyl-p-toluidino)fluoran, 2-amino-6-(N-propyl-2,4-dimethylanilino)fluoran, 2-amino-6-(N-propylanilino)fluoran, 2-am ino-6-(N-propyl-p-chloroanilino)fluoran, 2-amino-6-(N-propyl-p-ethylanilino)fluoran, 2-amino-6-(N-propyl-p-toluidino)fluoran, 2-anilino-3-chloro-6-diethylaminofluran, 2-anilino-3-methyl-6-(N-cyclohexyl-N-methylamino)fluoran, 2-anilino-3-methyl-6-(N-ethyl-N-isoamylamino)fluoran, 2-anilino-3-methyl-6-(N-ethyl-N-p-benzyl)aminofluoran, 2-anilino-3-methyl-6-(N-ethyl-N-propylamino)fluoran, 2-anilino-3-methyl-6-(N-iso-amyl-N-ethylamino)fluoran, 2-anilino-3-methyl-6-(N-isobutyl-methyl amino)fluoran, 2-anilino-3-methyl-6-(N-isopropyl-methyl amino)fluoran, 2-anilino-3-methyl-6-(N-methyl-p-toluidino-)fluoran, 2-anilino-3-methyl-6-(N-n-amyl-N-ethylamino)fluoran, 2-anilino-3-methyl-6-(N-n-amyl-N-methylamino)fluoran, 2-anii no-3-methyl-6-(N-n-propyl-N-isopropylamino)fluoran, 2-anilino-3-methyl-6-(N-n-propyl-N-methylamino)fluoran, 2-anilino-3-methyl-6-(N-sec-butyl-N-methylamino)fluoran, 2-anilino-3-methyl-6-diethylaminofluoran, 2-anilino-3-methyl-6-di-n-butylaminofluoran, 2-anilino-6-(N-n-hexyl-N-ethylamino)fluoran, 2-benzilamino-6-(N-ethyl-2,4-dimethylanilino)fluoran, 2-benzilamino-6-(N-ethyl-p-toluidino)fluoran, 2-benzilamino-6-(N-methyl-2,4-dimethylanilino)fluoran, 2-benzilamino-6-(N-methyl-p-toluidino)fluoran, 2-bromo-6-diethylaminofluoran, 2-chloro-3-methyl-6-diethylaminofluran, 2-chloro-6-(N-ethyl-N-isoamylamino)fluoran, 2-chloro-6-diethylaminofluoran, 2-chloro-6-dipropylaminofluoran, 2-diethylamino-6-(N-ethyl-p-toluidino)fluoran, 2-diethylamino-6-(N-methyl-p-toluidino)fluoran, 2-dimethylamino-6-(N-ethylanilino)fluoran, 2-dimethylamino-6-(N-methylanilino)fluoran, 2-dipropylamino-6-(N-ethylanilino)fluoran, 2-dipropylamino-6-(N-methylanilino)fluoran, 2-ethylamino-6-(N-ethyl-2,4-dimethylanilino)fluoran, 2-ethylamino-6-(N-methyl-p-toluidino)fluoran, 2-methylamino-6-(N-ethylanilino)fluoran, 2-methylamino-6-(N-methyl-2,4-dimethylanilino)fluoran, 2-methylamino-6-(N-methylanilino)fluoran, 2-methylamino-6-(N-propylanilino)fluoran, 3-(1-ethyl-2-methylindole-3-yl)-3-(2-etoxy-4-diethylaminophenyl)-4-azaphthalide, 3-(1-ethyl-2-methylindole-3-yI)-3-(2-etoxy-4-diethylaminophenyl)-7-azaphthalide, 3-(1-ethyl-2-methylindole-3-yI)-3-(2-methyl-4-diethylaminophenyl)-4-azaphthalide, 3-(1-ethyl-2-methylindole-3-yl)-3-(2-methyl-4-diethylaminophenyl)-7-azaphthalide, 3-(1-ethyl-2-methylindole-3-yl)-3-(4-diethylaminophenyl)-4-azaphthalide, 3-(1-ethyl-2-methylindole-3-yl)-3-(4-N-n-amyl-N-methylaminophenyl)-4-azaphthalide, 3-(1-methyl-2-methylindole-3-yl)-3-(2-hexyloxy-4-diethylaminophenyl)-4-azaphthalide, 3-(1-ethyl-2-methylindole-3-yl)-3-(2-ethoxy-4-diethylaminophenyl)-4-azaphthalide, 3-(N-cyclohexyl-N-methylamino)-6-methyl-7-phenylaminofluoran, 3-(N-ethyl-N-isoamylamino)-6-methyl-7-phenylaminofluoran, 3-(N-ethyl-p-toluidino)-6-methyl-7-phenylaminofluoran, 3,3-bis(2-ethoxy-4-diethylaminphenyl)-4-azaphtalide, 3,3-bis(2-ethoxy-4-diethylaminphenyl)-7-azaphtalide, 3,6-dibutoxyfluoran, 3,6-diethoxyfluoran, 3,6-dimethoxyfluoran, 3-bromo-4-cyclohexylaminofluoran, 3-chloro-6-cyclohexylaminofluoran, 3-dibutylamino-7-(o-chloro-phenylamino)fluoran, 3-diethylamino-5-methyl-7-dibenzylaminofluoran, 3-diethylamino-6-(m-trifluoromethylanilino)fluoran, 3-diethylamino-6,7-dimethylfuoran, 3-diethylamino-6-methyl-7-xylidinofluoran, 3-diethylamino-7-(2-carbomethoxy-phenylamino)fluoran, 3-diethylamino-7-(N-acetyl-N-methylamino)fluoran, 3-diethylamino-7-(N-chloroethyl-N-methylamino)fluoran, 3-diethylamino-7-(N-methyl-N-benzylamino)fluoran, 3-diethylamino-7-(o-chlorophenylamino)fluoran, 3-diethylamino-7-chlorofluoran, 3-diethylamino-7-dibenzylaminofluoran, 3-diethylamino-7-diethylaminofluoran, 3-diethylamino-7-N-methylaminofluoran, 3-dimethylamino-6-methoxylfluoran, 3-dimethylamino-7-methoxyfluoran, 3-methyl-6-(N-ethyl-p-toluidino)fluoran, 3-piperidino-6-methyl-7-phenylaminofluoran, 3-pyrrolidino-6-methyl-7-p-butylphenylaminofluoran, and 3-pyrrolidino-6-methyl-7-phenylaminofluoran.

Additional dyes that may be alloyed in accordance with embodiments of the present invention include, but are not limited to leuco dyes such as fluoran leuco dyes and phthalide color formers as are described in “The Chemistry and Applications of Leuco Dyes,” Muthyala, Ramiah, ed., Plenum Press (1997) (ISBN 0-30645459-9). Embodiments may comprise almost any known leuco dye, including, but not limited to, amino-triarylmethanes, aminoxanthenes, aminothioxanthenes, amino-9,10-dihydro-acridines, aminophenoxazines, aminophenothiazines, aminodihydro-phenazines, aminodiphenylmethanes, aminohydrocinnamic acids (cyanoethanes, leuco methines) and corresponding esters, 2(p-hydroxyphenyl)-4,5-diphenylimidazoles, indanones, leuco indamines, hydrozines, leuco indigoid dyes, amino-2,3-dihydroanthraquinones, tetrahalo-p, p′-biphenols, 2(p-hydroxyphenyl)-4,5-diphenylimidazoles, phenethylanilines, and mixtures thereof.

Particularly suitable leuco dyes include: 2′-Anilino-3′-methyl-6′-(dibutylamino)-fluoran: 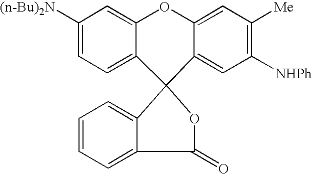
2-Anilino-3-methyl-6-(N-ethyl-N-isoamylamino)fluoran: 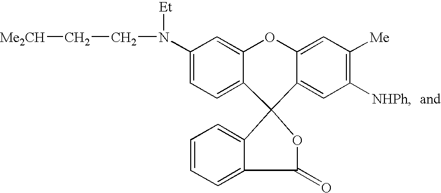
2-Anilino-3-methyl-6-(di-n-amylamino)fluoran:

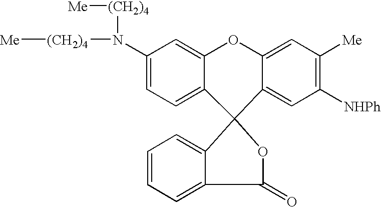

All three dyes are commercially available from Nagase Co of Japan. Additional examples of dyes include: Pink DCF CAS#29199-09-5; Orange-DCF, CAS#21934-68-9; Red-DCF CAS#2662847-7; Vemmilion-DCF, CAS#117342-264; Bis(dimethyl)aminobenzoyl phenothiazine, CAS# 1249-974; Green-DCF, CAS#34372-72-0; chloroanilino dibutylaminofluoran, CAS#82137-81-3; NC-Yellow-3 CAS#36886-76-7; Copikem37, CAS#144190-25-0; Copikem3, CAS#22091-92-5, available from Hodogaya, Japan or Noveon, Cincinnati, USA.

Additional non-limiting examples of suitable fluoran-based leuco dyes include: 3-diethylamino-6-methyl-7-anilinofluoran 3-(N-ethyl-p-toluidino)-6-methyl-7-anilinofluoran, 3-(N-ethyl-N-isoamylamino)-6-methyl-7-anilinofluoran, 3-diethylamino-6-methyl-7-(o,p-dimethylanilino)fluorane, 3-pyrrolidino-6-methyl-7-anilinofluoran, 3-piperidino-6-methyl-7-anilinofluoran, 3-(N-cyclohexyl-N-methylamino)-6-methyl-7-anilinofluoran, 3-diethylamino-7-(m-trifluoromethylanilino)fluoran, 3-dibutylamino-6-methyl-7-anilinofluoran, 3-diethylamino-6-chloro-7-anilinofluoran, 3-dibutylamino-7-(o-chloroanilino)fluoran, 3-diethylamino-7-(o-chloroanilino)fluoran 3-di-n-pentylamino-6-methyl-7-anilinofluoran, 3-di-n-butylamino-6-methyl-7-anilinofluoran, 3-(n-ethyl-n-isopentylamino)-6-methyl-7-anilinofluoran, 3-pyrrolidino-6-methyl-7-anilinofluoran, 1(3H)-isobenzofluranone, 4,5,6,7-tetrachloro-3, 3-bis [2-[4-(dimethylamino)phenyl]-2-(4-methoxyphenyl)ethenyl], and mixtures thereof. Aminotriarylmethane leuco dyes may also be used in embodiments of the present invention such as tris(N,N-dimethylaminophenyl)methane (LCV); tris(N,N-diethylaminophenyl)methane (LECV); tris(N,N-di-n-propylaminophenyl)methane (LPCV); tris(N,N-din-butylaminophenyl)methane (LBCV); bis(4-diethylaminophenyl)-(4-diethylamino-2-methyl-phenyl)methane (LV-1); bis(4-diethylamino-2-methylphenyl)-(4-diethylamino-phenyl)methane (LV-2); tris(4-diethylamino-2-methylphenyl)methane (LV-3); bis(4-diethylamino-2-methylphenyl)(3,4-diemethoxyphenyl)methane (LB-8); aminotriarylmethane leuco dyes having different alkyl substituents bonded to the amino moieties wherein each alkyl group is independently selected from C₁-C₄ alkyl; and aminotriarylmethane leuco dyes with any of the preceding named structures that are further substituted with one or more alkyl groups on the aryl rings wherein the latter alkyl groups are independently selected from C₁-C₃ alkyl.

Any suitable developer may be used with these dyes. According to certain embodiments of the invention, the desired developer is provided in the form of a precursor that can be photochemically or photothermally modified to become the desired developer. By providing the developer in precursor form, the need to physically separate the developer from the dye is eliminated. For example, rather than providing one of the color-forming components as particles that are suspended in the matrix, in embodiments of the present invention both the dye and the developer precursor can be dissolved in the matrix 140.

Developer precursors suitable for use in embodiments of the present invention include, without limitation, phenyl esters that undergo a molecular rearrangement so as to become phenolic compounds capable of developing (activating) the leuco dye. Such rearrangements are sometimes referred to as Fries rearrangements. Fries rearrangements can be thermally driven, but it will be understood that esters may undergo also photo-initiated Fries rearrangements (sometimes referred to as Photo Fries rearrangements), that both types of rearrangement are within the scope of the present invention, and that the stimulus for rearrangement may be light, heat, or a combination thereof.

In certain embodiments, suitable developer precursors include compounds having the formula
ROCOR′,
where R is an aryl group and R′ is an alkyl or aryl group. Exemplary compounds include, but are not limited to, di-O-acetylated and di-O-benzoylated curcuminoids. Alternatively, any aryl ester that absorbs or has a peak absorption wavelength between 380 nm and 420 nm and more particularly between 400 nm and 410 nm may be a developer precursor suitable for use in embodiments of the present invention.

Other precursors include ester precursors of developers such as bisphenol-A, bisphenol-S, hydroxy benzyl benzoates, TG-SA (phenol, 4,4′-sulfonylbis[2-(2-propenyl)]) and poly-phenols.

Although, as mentioned above, when the color-forming agent comprises a color former and a developer, such as in the case of a leuco dye, the matrix can be provided as a homogeneous, single-phase solution at ambient conditions because the use of a precursor for the developer prevents the color-forming reaction from occurring prior to activation. Nonetheless, in other embodiments, one or the other of the components may be substantially insoluble in the matrix at ambient conditions. By “substantially insoluble,” it is meant that the solubility of that component of the color-forming agent in the matrix at ambient conditions is so low, that no or very little color change occurs due to reaction of the dye and the developer at ambient conditions. Thus, in some embodiments, the developer is dissolved in the matrix with the dye being present as small crystals suspended in the matrix at ambient conditions; while in other embodiments, the color-former is dissolved in the matrix and the developer is present as small crystals suspended in the matrix at ambient conditions. The particle size is preferably less than 400 nm.

Laser light having blue, indigo, red and far-red wavelengths from about 300 nm to about 980 nm can be used to develop the present color-forming compositions. Therefore, color-forming compositions may be selected for use in devices that emit wavelengths within this range. For example, if the light source emits light having a wavelength of about 405 nm, the precursor can be selected to absorb and rearrange at or near that wavelength. In other embodiments, particularly those in which the developer precursor undergoes thermal rather than photochemical rearrangement, light sources of other wavelengths, including but not limited to 650 nm or 780 nm, can be used. In either case, a radiation absorber tuned to the selected wavelength can be included so as to enhance localized heating.

The matrix material can be any composition suitable for dissolving and/or dispersing the developer, and color-former (or color-former/melting aid alloy). Acceptable matrix materials include, by way of example only, UV-curable matrices such as acrylate derivatives, oligomers and monomers, with or without a photo package. A photo package may include a light-absorbing species which initiates reactions for curing of a matrix, such as, by way of example, benzophenone derivatives. Other examples of photoinitiators for free radical polymerization monomers and pre-polymers include, but are not limited to, thioxanethone derivatives, anthraquinone derivatives, acetophenones and benzoine ether types. It may be desirable to choose a matrix that can be cured by a form of radiation other than the type of radiation that causes a color change.

Matrices based on cationic polymerization resins may require photo-initiators based on aromatic diazonium salts, aromatic halonium salts, aromatic sulfonium salts and metallocene compounds. An example of an acceptable matrix or matrices includes Nor-Cote CLCDG-1250A or Nor-Cote CDG000 (mixtures of UV curable acrylate monomers and oligomers), which contains a photoinitiator (hydroxy ketone) and organic solvent acrylates (e.g., methyl methacrylate, hexyl methacrylate, beta-phenoxy ethyl acrylate, and hexamethylene acrylate). Other acceptable matrixs or matrices include acrylated polyester oligomers such as CN292, CN293, CN294, SR351 (trimethylolpropane tri acrylate), SR395 (isodecyl acrylate), and SR256 (2(2-ethoxyethoxy)ethyl acrylate) available from Sartomer Co.

The photochemical and/or photothermal mechanisms that cause the present developer precursors to become developers are much slower when the solid matrix is below its glass transition temperature. Without subscribing to a particular theory, the photochemical reactions in solids have an added energy barrier to heat the matrix above its glass transition temperature (T_{g}). Thus, in some embodiments, it is preferred to provide sufficient photothermal energy in the region of the desired mark to locally heat the matrix above its glass transition temperature T_{g}. T_{g} typically depends on the polymer composition of the matrix, and can be selected, if desired, by selecting the polymer that is used for the matrix. In some embodiments, T_{g} will preferably be in the range of 120 to 250° C.

The imaging compositions formed in the manner described herein are applied to the surface of an optical recording medium such as a CD, DVD, HD-DVD, BLU-RAY disc or the like.

The above discussion is meant to be illustrative of the principles and various embodiments of the present invention. Numerous variations and modifications will become apparent to those skilled in the art once the above disclosure is fully appreciated. For example, the nature of the substrate may be varied and the marking composition, antenna and matrix may each be varied from those identified herein. It is intended that the following claims be interpreted to embrace all such variations and modifications.

What is claimed is:

1. An optical recording medium comprising:
a substrate; and
a markable coating on said substrate;
said markable coating comprising:
a matrix containing a color-forming agent comprising a leuco dye and developer precursor;
wherein said developer precursor comprises a compound that undergoes rearrangement in response to a stimulus so as to become a developer.

2. The optical recording medium according to claim 1 wherein the developer precursor undergoes photochemical rearrangement to become a developer.

3. The optical recording medium according to claim 1 wherein the developer precursor comprises a phenyl ester.

4. The optical recording medium according to claim 1 wherein the developer precursor comprises a compound having the formula:
ROCOR′,
where R is an aryl group and R′ is an alkyl or aryl group.

5. The optical recording medium according to claim 1 wherein the developer precursor is selected from the group consisting of di-O-acetylated curcuminoids, di-O-benzoylated curcuminoids, and mixtures thereof.

6. The optical recording medium according to claim 1 wherein the developer precursor comprises an aryl ester having a peak absorption wavelength between 380 nm and 420 nm.

7. The optical recording medium according to claim 1 wherein the developer precursor comprises an aryl ester having a peak absorption wavelength between 300 nm and 980 nm.

8. The optical recording medium according to claim 1 wherein both the dye and the developer precursor are dissolved in the matrix.

9. The optical recording medium according to claim 1 wherein the leuco dye is selected from the group consisting of fluoran dyes and phthalide colorformers.

10. A method for optically recording data, comprising:
a) providing an optical recording medium comprising a substrate coated with a markable coating, said markable coating comprising:
a matrix containing a color-forming agent comprising a leuco dye and developer precursor, the developer precursor comprising a compound that undergoes rearrangement to become a developer; and
b) using energy having a predetermined wavelength to form an optically detectable mark in the markable coating.

11. The method according to claim 10 wherein providing an optical recording medium comprises providing a developer precursor comprising a phenyl ester.

12. The method according to claim 10 wherein providing an optical recording medium comprises providing a developer precursor comprising a compound having the formula:
ROCOR′,
where R is an aryl group and R′ is an alkyl or aryl group.

13. The method according to claim 10, wherein providing an optical recording medium comprises providing a developer precursor selected from the group consisting of di-O-acetylated curcuminoids, di-O-benzoylated curcuminoids, and mixtures thereof.

14. The method according to claim 10 wherein providing an optical recording medium comprises providing a developer precursor comprising an aryl ester having a peak absorption wavelength between 380 nm and 420 nm.

15. The method according to claim 10 wherein providing an optical recording medium comprises providing a developer precursor comprising an aryl ester having a peak absorption wavelength between 300 nm and 420 nm.

16. The method according to claim 10 wherein providing an optical recording medium comprises providing a recording medium in which both the leuco dye and the developer precursor are dissolved in the matrix.

17. The optical recording medium according to claim 10 wherein providing an optical recording medium comprises providing a recording medium in which the leuco dye is selected from the group consisting of fluoran dyes and phthalide colorformers.

18. An optical recording system comprising:
a disc comprising a substrate and a markable coating on said substrate, said markable coating comprising:
a matrix containing a color-forming agent comprising a leuco dye and developer precursor;
wherein said developer precursor comprises a compound that undergoes photochemical rearrangement to become a developer; and
a light source positioned so as to illuminate said disc in a desired manner so as to cause photochemical rearrangement of the developer precursor.

19. The optical recording system according to claim 18 wherein the developer precursor comprises a phenyl ester.

20. The optical recording system according to claim 18 wherein the developer precursor comprises a compound having the formula:
ROCOR′,
where R is an aryl group and R′ is an alkyl or aryl group.

21. The optical recording system according to claim 18 wherein the developer precursor is selected from the group consisting of di-O-acetylated curcuminoids, di-O-benzoylated curcuminoids, and mixtures thereof.

22. The optical recording system according to claim 18 wherein the light source provides light having a wavelength between 380 nm and 420 nm.
